(19) United States
(12) Patent Application Publication
(10) Pub. No.: US 2005/0289072 A1
(43) Pub. Date: Dec. 29, 2005

(54) System for automatic, secure and large scale software license management over any computer network

(76) Inventor: Vinay Sabharwal, Fremont, CA (US)

Correspondence Address: VINAY SABHARWAL, 43769 CAMERON HILLS DRIVE, FREMONT, CA, 94539, US

(21) Appl. No.: 10/879,541

(22) Filed: Jun. 29, 2004

(51) Int. Cl. G06F 17/60

(52) U.S. Cl. 705/59

(57) ABSTRACT

An improved license management system that enables large-scale, secure and automatic activation and migration of software licenses across computers on any network is disclosed. The system comprises a network license server that maintains detailed licensing limit and state in persistent store, and client libraries that are used by applications to issue activation and deactivation requests to the license server and to securely manage the activation state in local persistent store. An application is protected when it has activated its license for a lease duration. Activation is not constrained to coincide with an application's installation or running state. There are two types of licenses: anonymous licenses that exist while the license is activated, and named licenses that have user authentication information and an activation state. One embodiment of the license server is an HTTP protocol based web server application using a relational database management system for persistent storage.

### CROSS-REFERENCE TO RELATED APPLICATIONS

Not Applicable.

### STATEMENT REGARDING FEDERALLY SPONSORED RESEARCH OR DEVELOPMENT

Not applicable.

### BACKGROUND

1. Field of Invention

This invention relates to the protection of software programs from piracy, unauthorized use and oversubscription of licensed terms of use.

2. Description of Prior Art

Most software that is marketed today is not protected with license management technology, and instead legal agreements are relied on for enforcement of license terms. While part of the reason for this state of affairs is the relative immaturity of the license management software market and a general lack of awareness of available licensing options, a significant contributing factor is the immature state of license management technology itself:
(a) Technology that is effective in preventing software piracy also proportionally inconveniences customers, thereby serving as a sales inhibitor in commodity software markets.
(b) Technology that is effective in preventing software piracy imposes significant logistics overhead on both the end customer and the software vendor, thereby adding to the cost of doing business.
(c) Technology that supports the concept of sharing a limited pool of licenses among a larger population of potential users is limited in scope and scalability, imposes an administrative burden on the end customer, and adversely impacts both the security of the licensing system and the availability of protected applications in the event of server and network outages.
(d) Available license management technologies are unsuited for operating in modem wide area networks such as the Internet or inherently unreliable networks such as wireless networks.

The primary purpose of this invention is to address the current limitations of the license management technology so as to provide a solution that:
(a) Is robust and secure and at the same time provides the end user the freedom and flexibility.
(b) Automates the logistics of fulfilling license requests and relocating licenses among machines over time.
(c) Extends the scope of floating licenses to make it more useful and scalable such as to eliminate the administration overhead and reliability constraints normally associated with floating licenses.
(d) Is appropriate for operating in modem wide area networks such as the Internet as well as wireless networks such as 802.11.

Software that is protected with license management technology today utilizes license management systems that usually fall into one of the following categories:

(a) Soft Licensing:

A unique encrypted key either accompanies a product media distribution or is distributed separately as part of order fulfillment The software requires a valid encrypted key in order to run, and may even prompt for and match a product serial number, username or product code against a code that is encrypted in the key, in addition to matching other encoded criteria such as the application name. Correspondingly, the protected software is either linked with license management libraries that perform license checks on the key, or is encapsulated in “wrapper” software that uses the license management libraries.

The process of generating a soft license by a vendor is simple: multiple license keys can be produced in a batch prior to order fulfillment without requiring prior knowledge of the machines on which they will be used.

The process of moving a license with a user across machines is also simple: if the protected software is to be re-hosted to another machine, for example if the current machine experienced a failure, the end user may simply reinstall the application and supply the same license key.

Soft licensing solves the problem of eliminating crimes of opportunity by separating the program media from the license, and can work reasonably well with reputable customers whose management provides a directive to all employees to ensure that all software that is used is licensed. In this case, the license management system serves the purpose of providing for accountability and identification.

Soft licensing suffers from the obvious deficiency that its attributes of convenience and flexibility are at the expense of security and oversubscription to licensing terms: nothing prevents a dishonest user from installing and simultaneously using multiple copies of the licensed software beyond the paid-for number of copies, or worse, widely distributing the license key to large numbers of users. For this reason, soft licensing is unsuitable for most applications, particularly consumer applications.

(b) Node Locked Licensing Based on Hardware Dongles:

A platform-specific physical hardware device (“dongle”) having a unique identifier is shipped together with the software package and is required to be inserted into a machine's port before the licensed software can be fully functional on the machine. The dongle is optionally accompanied by a soft license key that is locked to the dongle rather than to the machine and that defines licensing policies for use in conjunction with the dongle. Correspondingly, the protected software is linked with license management libraries that perform license checks on the key and dongle, or is encapsulated in “wrapper” software that uses the license management libraries.

The process of fulfilling an order by a vendor requires the vendor to physically configure a dongle with a unique identifier and to physically ship it to the customer, typically by including it with a physical software package distribution such as a CD-ROM. It is not an option to distribute dongles electronically or to provide a self-service model whereby the customer obtains their own dongles without compromising security. There is also a fixed cost associated with a dongle, since it is a physical device that has to be purchased from an electronics manufacturer.

The process of moving a dongle-based license with a user across machines is simple: if the protected software is to be re-hosted to another machine, for example if the current machine experienced a failure, the end user may simply reinstall the application, unplug the dongle from the previous machine, and plug it into the new machine.

Dongles can be highly effective against piracy as they are difficult to clone. The primary disadvantages of dongles are the high fixed cost, the high cost of operations due to elimination of the electronic software delivery option, and the high development costs to the vendor and inflexibility to the end customer for applications intended to run on multiple platforms. Dongle-based licensing systems also typically provide fewer licensing options such as term licensing and metering as these are more effectively implemented in software-based systems.

(c) Node Locked Licensing Based on Machine Fingerprints:

Node-locked licensing technology solves the problem of preventing a license key from being used on any machine other than the one for which it is intended. At the time of order fulfillment a vendor's operations personnel or back office computer system locks a license to a specific target machine at the time a license key is generated in response to fulfilling an order. An additional step in the fulfillment process involves obtaining the end user's parameters. When the application is installed or activated at the end user's machine, and subsequently whenever the application is executed, the application logic compares the machine information encoded in the license key with the actual program execution environment as part of validating the license. If the machine fingerprints don't match, the application is programmed to fail or operate with degraded functionality. Therefore, a given license key can only be used successfully on the designated machine.

Node locked licensing can be effective in preventing piracy to the extent that the node locking algorithm and implementation are secure. The security is at the expense of convenience to the end user: whenever a user needs to make a planned or unplanned migration to a new machine, it is necessary to involve the vendor's operations personnel to deactivate the current installation and/or prove that the machine was lost or stolen, and then obtain a new license key for the new machine. When the license is perpetual, the loss due to piracy can be unlimited when users retain existing licenses and obtain new licenses for allegedly-lost machines.

(d) Node Locked Licensing With Internet-Based Automatic Activation:

Some of the inconvenience associated with node-locked licensing can be alleviated by combining it with Internet-based activation using a central license activation server that is hosted by the vendor. With this approach, the order fulfillment process generates a unique product serial number for a given software license independent of where the software will be installed, and this serial number is provided to the end customer, who is not required to provide any machine-specific information to the vendor. The vendor's operations personnel or back office system also records the serial number in a database and marks it as being in a non-activated state. At the time of product activation, typically during product installation, the user is required to enter the assigned product serial number, which is then communicated over the Internet to the vendor's license activation server. Activation is successful provided the serial number is valid and not currently in an activated state. If successful, the vendor's license activation server returns an “unlock code” based on the product serial number and the machine's fingerprint. The unlock code is stored locally in a secure manner, and is subsequently checked each time the licensed application is run without requiring an Internet connection. An automatic deactivation mechanism may also be provided, whereby the end user may deactivate their license over the Internet so as to be able to reactivate it on a new machine. A variation of the scheme allows for scenarios where no Internet connection is available: in this case, a backup telephone-based activation system may be provided, possibly in conjunction with a back end Interactive Voice Response system. The offline activation process involves the application software providing a concise string of digits representing the machine fingerprint and product serial number and intended to be recited by the user over the telephone. The back office system responds with a concise string of digits representing the unlock code which the end user inputs into the application in order to complete the activation process.

While a significant improvement over conventional node locked licensing, the existing approach continues to suffer from a number of limitations:
(i) it does not support automatic deactivation in the scenario where an Internet connection is unavailable.
(ii) it is vulnerable to piracy: subsequent to activation, the unlock code may be copied to other machines for unlicensed use.
(iii) if safeguards such as multiple obfuscated locations are used in order to protect from the vulnerability to piracy described in (ii) above, it is difficult to erase an existing installation from a machine in order to perform a fresh product installation.
(iv) re-activation of a license on a new machine is not automatically accompanied by a transfer of the application's context such as user preferences and other state information; these must be manually reconstructed on the new machine.
(v) manual intervention is required by the vendor's operations personnel to release the license in the event of a lost or failed machine, in order to reuse the license on a new machine, and further, such a scenario is vulnerable to indefinite license oversubscription when the machine was not in fact lost.

In summary, existing approaches to node-locked licensing based on Internet and phone based activation systems are quite effective at preventing piracy and reducing the cost of operations; however, they do not effectively solve the problem of allowing end-users to relocate their license among multiple machines and have their licenses travel with them with any realistic level of frequency and flexibility.

(e) Concurrent Floating Licensing:

A concurrent-user floating license management system is intended to enable a business model whereby a software vendor can price a product according to the number of users that may simultaneously use the software product, typically with no constraints imposed on the specific machines on which the application may run or the number of machines on which the application may be installed.

The limits on floating license pools for specific products are specified by the vendor in a file that specifies limits and other parameters in plaintext, accompanied by a certificate that is required to match the plaintext contents to prevent tampering. The limits are imposed by running a network license server to which a running application connects for the purpose of checking out a license from a limited pool of licenses that is maintained in memory by the license server. The license server does not maintain significant license state information in persistent storage.

When an application begins execution, it first acquires a connection to the license server and performs a “checkout license” operation, and if successful, enables full application functionality to the user. When the application terminates, or if it performs an explicit “checkin license” operation, its license is released back to the pool. While the application executes, it retains a continuous network connection to the license server that it utilizes for polling the server in order to ensure the license server is running so as to prevent oversubscription caused by recycling the license server, which loses its license information if it shuts down. If an application needs to checkout a license and operate in disconnected mode, it utilizes a “license borrowing” mechanism whereby a connected “borrow” utility is run that performs the checkout on behalf of the disconnected application. Since the borrowing mechanism represents a vulnerability to piracy, the vendor controls whether to grant permission to perform borrowing to its customer.

Variations of the above approach to floating licensing sometimes include mechanisms for temporarily locking a license to a specific machine with a dongle, and may employ distributed license server functionality where nodes communicate with each other to locate and share a limited pool of licenses amongst a potentially large number of nodes. Additionally, since the approaches require the license server to be available in order for the protected applications to run, an overdraft facility is usually provided that permits limited-time normal operation of the application in the event a connection to the license server cannot be established or an existing connection is broken. The servers are also designed to be highly redundant for high availability.

The current approaches to floating licensing are suitable for protecting high-value enterprise applications in local area network environments where the number of nodes communicating with each other or with a central license server is not large, the number of protected applications is limited, the licensing requirements are limited to basic concurrent-user license management, and the deployment environment is relatively trusted.

In all other scenarios, existing architectures have serious deficiencies:
(i) They require that one or more license server processes be administered at the end customer site by the end customer's administrator, as their network connectivity requirements preclude their large scale deployment over the Internet. This means that license protecting software has the side effect of introducing an administration burden to the end customer, and it is not an option for the software vendor to host the license server at their premises on behalf of their customers.
(ii) They are inherently vulnerable to network outages due to their dependency on continuous network connectivity to the license server, even if the license server itself is configured for high availability through redundancy. This means that protected applications may not run securely in the absence of network connectivity to the license server.
(iii) They pose an inherent tradeoff between security and availability: to the extent that the availability demands are relaxed, for example using overdrafts and stretching keep-alive heartbeat intervals to be infrequent, the system is vulnerable to oversubscription of licensing terms.
(iv) The floating licenses are anonymous: there is no option to explicitly associate a license with a named user and to require authentication from the named user. Therefore, there is no option that allows an individual to be associated with a license that travels with the individual across machines. As a result, the scope of today's floating licensing systems is limited to managing a pool of licenses among anonymous users on a local area network.
(v) The approach is conceptually unsound as the concept of licensing is tightly coupled with the actual execution of the protected application: the protected application or a proxy thereof is required to be running in order to be protected. That is, there is no concept of checking out a license and keeping it checked out for durations extending past the execution lifetime of the application. Stated another way, the concepts of activating and deactivating a floating license for an application installation is indistinct from the application's execution. As a result, the scope of today's floating licensing systems is limited to managing a pool of licenses among actively-executing enterprise desktop application instances on a local area network.
(vi) Current floating license server technologies have additional inherent vulnerabilities to piracy: they do not protect against spoofing of the license server, and they do not prevent a customer from manufacturing their own license keys for use with their vendors' products.

Floating and node locked licenses usually have a variety of licensing policies associated with them, such as time limited licenses, usage limits, and features. Dongle-based node-locked licensing systems are typically less flexible in this regard.

Standalone node locked licensing systems have an inherent vulnerability to oversubscription of time limited licenses: regardless of the mechanisms that are included by the vendor for the purpose of thwarting attempts at turning back the system clock, for example by using hidden files and registry entries or by checking specific operating system files' timestamps, these are all easily bypassed by reformatting the disk drives and reinstalling the operating system with the system clock turned back. This is a particularly important issue for high-value software that is sold on a term subscription basis and warrants this level of piracy effort.

To summarize, the following problems exist with today's license management systems:
1. Architectures and systems supporting floating licenses are limited in scope, security, availability and scalability, and in particular they are not suitable for secure and large-scale Internet-based deployment.
2. Existing node locked systems, including Internet-based activation systems, do not provide mechanisms that enable users to conveniently carry their licenses with them across machines such that the mechanisms are both flexible and secure.
3. Existing license management systems are inherently vulnerable to oversubscription of time limited licenses while disconnected from a license server.

### SUMMARY

The invention, whose main embodiment is referred to as Orion, provides a new and improved server-based license management system that allows for large-scale secure, automatic and non-intrusive activation and migration of software licenses across computers on a potentially slow and unreliable local, wide-area or wireless network or across disconnected networks.

Briefly, the license management system consists of a network license server that centrally maintains licensing information, and client libraries that are used by protected applications to communicate with the license server as well as to manage autonomous license checks while disconnected from the network. The license server and client libraries utilize a stateless network communication protocol. AU central and local license state information is maintained in persistent store that survives application and system failures. The license server's persistent store is based on a database management system. The client libraries provide programming interfaces that enable applications to activate licenses from the license server for programmable lease durations, and to securely save and restore the license activation state in local persistent store for the purpose of securely performing license checks while disconnected from the network during normal operation. The license server and client libraries also provide a self-service facility that enables a disconnected application to securely perform its activation and deactivation by having the end user utilize a proxy program on a different machine that does have network connectivity to the license server. The dynamically-generated license key belonging to an activated application installation is timestamped with the server's clock and is non-transferable to other machines. An application's activated state is unaffected by whether the license server or application is running. Individual licenses obtained from the license server may be of two types: anonymous licenses that come into existence upon an activation request and disappear upon deactivation, and named licenses that are preconfigured by the administrator of the license server and have a user name, an optional password, and an activation state associated with them. Named licenses consume licenses from the pool regardless of their activation state. An end user who is identified by a user name and an optional password may have multiple installations of the licensed application at multiple locations, and may make licensed use of the application at only one location at a time, but may conveniently move among installations. No network connectivity is required during the normal and potentially indefinite lifetime of an application installation. All communication between the client and license server is based on public key encryption technology that provides protection from eavesdropping, spoofing and cloning of floating license keys by basing public and private keys on a vendor-specified secret password.

### OBJECTS AND ADVANTAGES

Based on the description of the invention, it can be seen that it offers the following benefits over previous solutions:

1. Improved Revenue Realization: Elimination of Opportunities for Piracy

Orion eliminates key vulnerabilities in existing licensing systems, such as:
(a) vulnerability to oversubscription as a result of license server unavailability or relocation of a license to a new machine due to an alleged failed machine
(b) vulnerability to spoofing of a license server with one that provides affirmative responses to license requests
(c) vulnerability to changes in the client machine's system clock for the purpose of oversubscribing time limited licenses
(d) vulnerability to oversubscription of licenses by customers who manufacture their vendors' keys for unlicensed use of the vendors' products

Further, should the system be compromised, the extent of damage can be contained to an assigned activation lease interval.

2. Improved Long Term Revenue Realization: Availability of Business Intelligence on Software Usage and Sales

By maintaining licensing information in a relational database instead of in memory or in a file system, and by centrally recording product activations together with usage information captured during renewal of activation leases, the vendor is readily able to run and rapidly develop new business intelligence reports on software usage and sales by applying declarative relational calculus operations on the database using the SQL database language and off-the-shelf SQL-based reporting tools.

3. Enhanced Customer Acceptance of Vendor Software: Flexibility to End User Without Compromising Security

A user's license is not irrevocably locked to a specific machine, and the user can rapidly migrate his/her license across machines while preserving his/her application state and without being required to endure complicated procedures. At the same time, software vendors are secure in the knowledge that unlicensed use of their software is not possible as a consequence, and the vendors may centrally control the degree of flexibility they provide to their customers by limiting the frequency of migrations and the duration for lease intervals.

This benefit is available to end users of both consumer desktop software and enterprise software.

4. Enhanced Enterprise Customer Acceptance of Vendor Software: Reduced Cost of Ownership

Automation of day-to-day migrations of end user licenses across machines combined with elimination of the need to locally administer a license server translate into lowered operational costs for enterprise software customers' administration staff

5. Reduced Cost of Ownership for Software Vendors Through Electronic Software Distribution Support and Automation of Day to Day Operations

Vendors can fully automate the order fulfillment process to the point of not requiring up front information from the end customer, and not being required to follow up an order with the delivery of license keys.

Vendors' operations personnel are also not involved when their customers relocate their licenses across machines, even when the end user's machine does not have Internet connectivity. Even if the end user's machine is lost or stolen, the vendor can arrange to not be involved by adopting a policy of leasing activations for finite time periods. The only time the vendor's operations personnel are required to incur operations overhead is when the vendor's license server is down or is inaccessible at the time an end customer attempts an activation or deactivation. The vendor can eliminate even this overhead by permitting activation overdrafts.

Vendors are also not required to develop and manage systems for generating and distributing license keys. A protected application either automatically acquires and locally generates its license key over the network or, if the application does not have network connectivity, the end user achieves the above on behalf of the application via a proxy utility program or web self-service page.

6. Enhanced Customer Acceptance: Global Workforce Productivity

Orion's Internet and hosting capabilities enable a software vendor's enterprise customers' global workforce to pool a limited number of floating licenses across multiple time zones, enabling them to utilize their capital expenditure on the vendor's software more effectively. At the same time, the degree of sharing of the licenses can be centrally controlled by the vendor.

### DRAWING FIGURES

FIG. 1 illustrates the core Orion license server based system architecture. It shows the interrelationship between the primary components of Orion and how they interact.

FIG. 2 illustrates the database-resident license repository data model in detail, and includes a notational reference.

FIG. 3 depicts the licensing scenario when an application installation's license activation and deactivation are automatically performed over an available network connection to the license server.

The corresponding licensing scenario in the absence of an available network connectivity to the license server from the application installation is illustrated in FIG. 4.

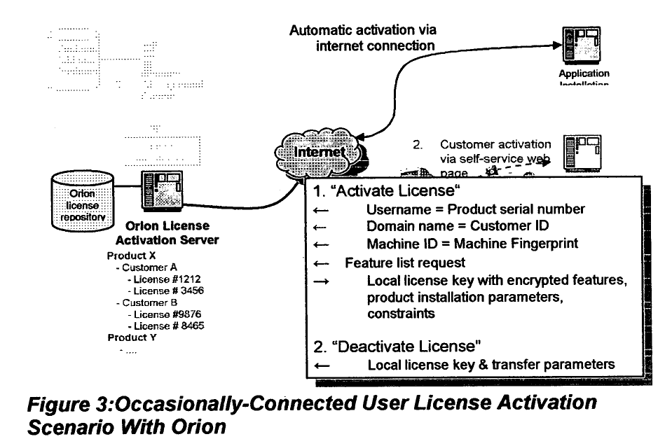

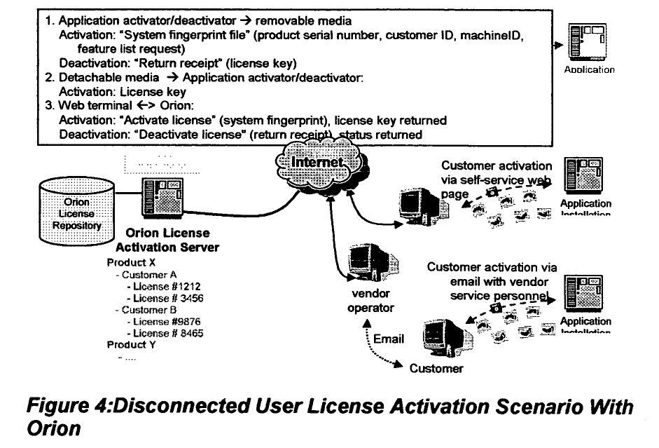

In FIGS. 3 and 4, Orion is referred to as a “license activation server”, and the Orion concepts of “domain” and “user” are mapped to the external concepts of Customer and License.

### DESCRIPTION

The description that follows describes the preferred embodiment of the invention where:
(e) all network communication is performed over the stateless HTTP Internet protocol.
(f) the license server is a Java server application that can run on any J2EE application server or servlet engine.
(g) the client libraries are implemented in Java and C++.
(h) the database management system used to implement the server license repository persistent store is a JDBC-compliant relational database management system.
(i) the persistent store used to save a local license key for an activated application installation is a conventional disk file or an operating system registry entry or property file entry resident on the client machine.
(j) the proxy mechanism that is used to enable an end user to acquire and return licenses on behalf of a disconnected application is a web self-service page implemented using JSP and Java.
(k) the user interface that is used to perform administration of the license server and its repositories is implemented using JSP and Java.

Prerequisites for understanding the description below include a basic awareness of Internet technologies, relational database technologies, data modeling terminology, Java/J2EE terminology, and encryption technologies including public key cryptography.

### Overview of Orion Architecture

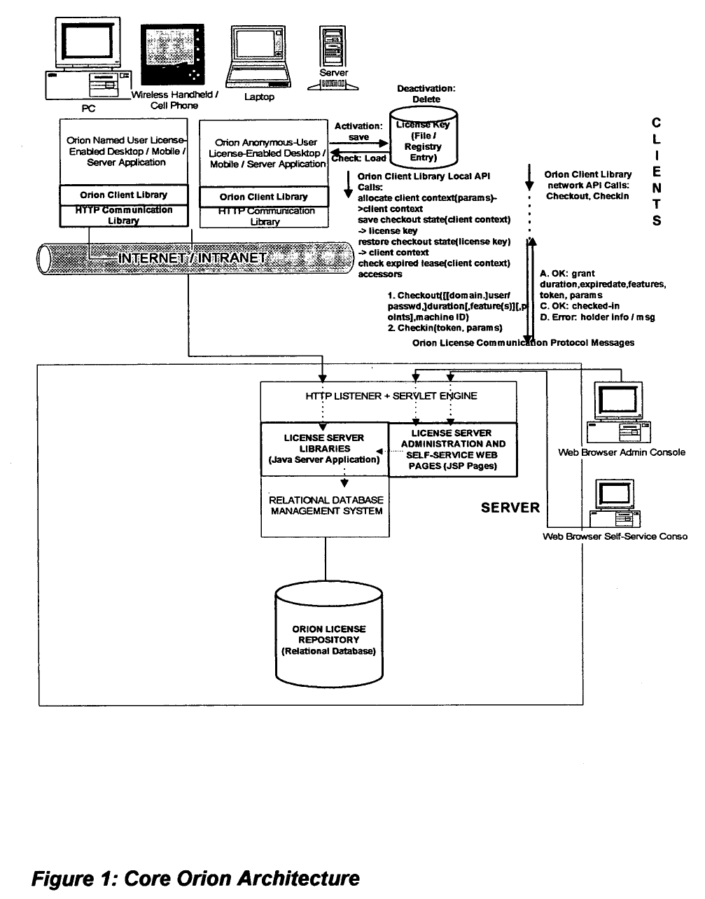

As indicated in FIG. 1, the key components of the invention are the license repository, the license server, the client/server license communication protocol, the proxy mechanism implemented as a web browser based self-service system for permitting secure activation and deactivation in the absence of network connectivity, and the client run time library. An additional administration user interface component is provided in both command line and web browser variants.

The core license server is a web-based Java database application that includes its own HTTP listener, servlet engine and relational database management system. Orion may also be deployed under any industry-standard J2EE application server or servlet engine, optionally fronted by a web server such as Apache if the application server/servlet engine either does not provide a direct HTTP listener, or Orion is being deployed in an existing web configuration, and may be used with any JDBC-compliant relational database management system.

A desktop, server or mobile application is license-enabled with Orion by coding it to issue and respond to API calls to the Orion client library which is linked with the application. The Orion client library exports API calls that execute locally without communicating with the license server, as well as API calls that require communication with the license server. The latter issue and respond to messages that conform to the Orion License Communication Protocol, which is a published application-level protocol layered on top of HTTP. At a basic level, two simple command strings are sent over the HTTP protocol together with their associated parameters: a “checkout” command and a “checkin” command. These server to provide the basis for the activation and deactivation functions respectively. The activation and deactivation functions further utilize autonomous Orion client library calls to serialize and encrypt the checked out state and to decrypt and deserialize the checked out state, respectively. Additional calls are available for autonomously initializing and introspecting the license state and for managing hidden files to detect tampering of the system clock on the client machine. In a simple scenario, an application may implement lightweight activations and deactivations that are limited in scope to the actual execution time of the program, in which case it simply performs the basic “checkout” and “checkin” requests, without being required to perform complete activations and deactivations or to save the checked out state in persistent store.

The end-user licenses are tracked by the Orion license server in its license repository, which is maintained in the included relational database. The repository is organized according to a structured data model that is described below.

The Orion license server itself can be configured to be Orion-enabled so that floating license keys can be obtained from another Orion server instance. Alternatively, the floating license key is generated with a traditional standalone license manager product that is cognizant of Orion functionality.

Orion's Licensing Models

Orion supports two types of licensing models: anonymous users and named users.

An anonymous user licensing model license allows multiple installations of an application to share a limited named pool of licenses. The individual active users are unnamed. This is a traditional floating license model.

A named-user licensing model adds to floating licenses the concept of a pre-registered logical named user that is not associated with a single specific machine during its lifetime: an administrator adds a user name, optionally accompanied by a password, to the license server, thereby unconditionally consuming a license from the available license pool. The user can be in a dormant or activated state. When the user is in an activated state, it is associated with a single specific machine for a specific activation lease interval. Unlike a traditional fixed named-user license, a named user license allows a given application installation's license to be transferred from one user or machine to another, simply by deactivating the license from one machine and reactivating it on the new machine.

A single Orion instance can simultaneously support multiple named pools of named and anonymous licenses.

Orion's Activation-Based Autonomous License Checking Model

The core of Orion's licensing approach, and what differentiates it from traditional floating license servers as well as conventional license activation systems, is its concept of “leased license activation” that applies to both named and anonymous licensing models and enables Orion to achieve the high levels of scalability and availability that are required for effective large-scale Internet-based deployment.

Traditionally, the lifecycle of an application installation can cause it go through the well-defined steps of application installation, application execution, and application uninstallation. The application is first installed on a specific machine, then executed multiple times over a period of time, and it may then be uninstalled, after which the application is not usable. Traditionally, the activation of the application installation's license is performed exactly once during its lifetime, typically at the time of installation, or subsequently when it is run and is discovered to not be in an activated state. If the product is uninstalled, its license may be deactivated at that time. In between, the application is in an activated and usable state. The disadvantage of this traditional approach is that moving a license from an application installation on one machine to an application installation on another machine is a time consuming and disruptive action that cannot be performed with any reasonable degree of frequency and autonomy: the process of installing a product can be complex and time consuming, no context is automatically transferred from the existing installation to the new installation, and manual intervention by the vendor's operations personnel is usually required. Further, such a traditional license activation system does not allow for the pooling of a limited number of licenses among anonymous users—to achieve this, one normally resorts to a conventional floating license server and sacrifices the notion of an activation lifetime extending beyond an execution boundary.

To overcome the limitations of a traditional approach, Orion separates the notion of license activation and deactivation from product installation and uninstallation, and permits a given application installation to be activated and deactivated multiple times during its lifetime so as to permit frequent and convenient migrations of product licenses among machines while leaving multiple existing application installations intact. The application provides user interfaces or utilities to perform a simple and efficient “activate” or “deactivate” operation for a vendor-specified activation lease duration. Activation is permitted when the application is in a deactivated or activated state; in the latter scenario, the activation is essentially a reactivation that refreshes licensing parameters from the license server as well as to extend the license lease for the duration value that is currently in effect in the license server configuration.

Orion Conceptual Schema

The key actors and entities in an Orion- and Internet-based ecosystem are:
(l) Zero or more License Service Provider companies that host and operate Orion over the Internet on behalf of multiple software vendor companies
(m) One or more software vendor companies who license their respective products to multiple end customers
(n) One or more end customer companies who license products from one or more software vendors and who in turn have multiple end users
(o) One or more end users belonging to each end customer
(p) One or more Orion instances, which are instances of an Orion product installation hosted either by a License Service Provider, a software vendor, an end customer, or an end user. An Orion instance comes into being as a result of an Orion license server product installation procedure, and ceases to exist when the license server is uninstalled.
(q) One or more instances of an Orion license repository, called a service, belonging to each specific Orion installation. Multiple services can be added to and removed from an Orion instance during the latter's lifetime.

As a result, there is a many-to-many relationship between Orion instances and software vendors. The intersection entity is the Orion service: a given service is for a specific Orion installation and directly or indirectly on behalf of a specific software vendor.

The remaining relationships are captured in the service repository's logical data model. The service repository corresponds to a relational database schema in the ANSI SQL sense, and contains a set of tables according to a data model described below.

License Repository Logical Data Model

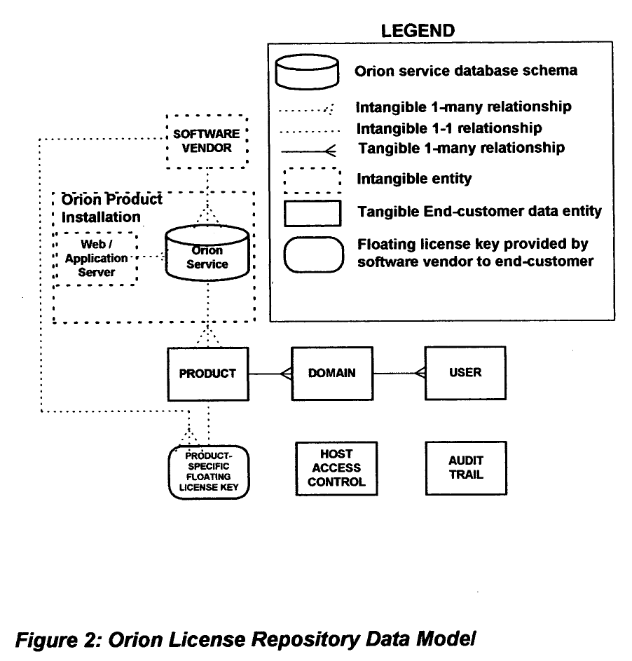

The key entities in the license repository, illustrated in FIG. 2, are:
(a) Product: this is the entity representing a specific licensed application. There may be multiple products defined in the repository for the purpose of protecting multiple applications. A product is identified by its name, which is unique within the scope of the service. Dependent attributes of the product entity include an encrypted floating license key that defines enabled features and a weighted floating user limit as well as various licensing policies at an aggregate level including expiration date, metered quota limit, and parameters constraining the absolute minimum and maximum activation lease intervals. The floating license key is provided by the software vendor in response to an order fulfillment. No information other than the product name and floating license key are required to be provided by the software vendor.
(b) Domain: this is an entity representing a license administration sub-domain that is optionally created by the end customer or preconfigured by the software vendor for the purpose of further constraining licensing limits, policies and features for a group of users. A domain can be viewed as a role or a group; however, its purpose is sufficiently general that it can be used for a wide range of identified and unanticipated usage scenarios. A domain is identified by a name assigned at the time of its creation, which is unique within the scope of the product. Dependent attributes of the domain include its type, which indicates whether it is for named or anonymous users; licensing policy parameters, features and limits that represent a further constriction of the product level license parameters, including the upper and lower bounds on activation lease duration. A product may have multiple domains, and a domain belongs to one and only one product. When a product is created, a default domain for each of the named-user and anonymous-user license models is automatically created. Subsequently, so long as the product entity exists, multiple domains of both types may be added or removed from the product.
(c) User: this is an entity representing a single instance of a named or anonymous user in the context of its owning domain, where a user is typically a licensed user of a desktop or server application or a user registered with a licensed server application. The concept of a user is however sufficiently general purpose to permit it to represent any real world entity, for example product codes, product serial numbers, software module names. A domain may have multiple users, and a user belongs to one and only one user. A user is uniquely identified by a name. The existence of a user counts towards the weighted user limit defined in the product's floating license key and further constrained in the user's owning domain, by an amount equal to the weightage assigned to the user. The lifetime of a user depends on its type: a named user is created or dropped as a result of an explicit administrative action, whereas an anonymous user is automatically created/reused and dropped/released as part of an anonymous-user activation and deactivation request respectively. The dependent attributes of a named user are a superset of those for an anonymous user, owing to its different level of functionality. The name for a named user is explicitly assigned by an administrator. The named user may also have an optional password associated with it. In addition, the named user may have user-specific licensing parameter information associated with it that serves to further constrict the owning domain-level license policies, features and limits. A named user also has an activation status that indicates whether it is currently in an activated state, and user-defined parameter information for saving and recovering application installation state information across successive activations on different machines. An anonymous user, on the other hand, has a system-assigned name and is implicitly activated by virtue of its existence. Both types of users have attributes representing the runtime state of the user, including the machine identifier representing the client machine from which the user is currently activated, metered usage consumption, the activation lease duration, and the date and time of activation. The runtime state also includes an encrypted license token which is manufactured and retuned to the client in response to a checkout request, and which is matched with an incoming token in response to a checkin request. The encrypted token contains particulars about originating and destination machines, clock timestamps, and all checkout state information.
(d) Audit Trail: this entity is used to track both administration and user activities for retrospective analysis and audits. Entries are categorized in multiple dimensions in order to facilitate report generation as well as to conduct focused searches. An audit trail entity is uniquely identified by an internally generated unique identifier. Its dependent attributes include the event timestamp, event identification and categorization attributes, data values, event severity and verbosity indicators. The entity has an optional one-to-one relationship with each of Product, Domain and User.
(e) Host Access Control: the entity is used to define “allow” and “deny” rules that control the client machines whose requests are permitted to be processed by Orion. The rules are based on regular expressions. A host access control entry is uniquely identified by an administrator-specified name, and its dependent attributes include its pattern matching rule and whether the rule is an “allow” or “deny” rule. The semantics of the rule are: a client request is permitted provided its machine ID satisfies at least one “allow” rule and does not satisfy any “deny” rule. When the repository is created, its host access control table is initialized with a single “allow all” rule.

The above data model is normalized to at least third normal form for run time efficiency and data consistency. In particular, information such as counts of in-use licenses are not maintained in redundant fields and are instead computed on demand using SQL aggregate queries. SQL is used to accomplish all license repository information manipulation and retrieval for the purpose of performing administration and license checking functions. In particular, a user license whose lease has expired requires no cleanup, as the SQL query used to count active licenses automatically filters out the user with the appropriate time-based predicate. Expired user entries are automatically detected and garbage-collected as a side effect of verifying an incoming checkout request, eliminating the need for a background cleanup daemon.

Basic reporting and business intelligence functions are possible with the above data model via vector aggregate SQL queries that are executed against the database tables comprising the license repository.

Secure Communication

A built-in secure communication mechanism is provided so as to alleviate the customer from the burden of acquiring and installing certificates from certificate authorities and configuring the web server for SSL based secure communication, and also in order to simultaneously solve the problem of preventing the end customer from manufacturing their own keys for use with their vendors' products.

Communication between the Orion client and license server is secured using public key cryptography for the purpose of preventing server spoofing and license key cloning attacks. A secret key is associated with the definition for a product at the software vendor's premises. From this secret key, an asymmetric key pair, corresponding to a private key and a public key, are derived by the license management software. The vendor's license management system that is used to produce floating license keys for Orion makes available to the vendor the corresponding public key, and makes the corresponding private key available to the Orion system software. The vendor embeds the public key in the protected application, and provides it to the Orion client library for the checkout and checkin API calls that communicate with the license server.

When secure communication is enabled, each request to the license server is asymmetrically encrypted with the above public key. Correspondingly, the license server asymmetrically decrypts the request with the corresponding private key that only it knows about from the decrypted contents of the floating license key. The license server asymmetrically encrypts its response to the client with its private key, and correspondingly the client decrypts the response with its public key.

If, for an application, a customer substitutes his/her own floating license key purporting to be that from the application's vendor, the encrypted message from the client will not be successfully decrypted. Similarly, if a customer develops a license server that conforms to Orion's communication protocol for the purpose of unconditionally granting checkout requests, the spoof server will be unable to successfully decrypt and encrypt communication with the client. In a similar vein, privacy and integrity of the traffic between the client and the license server are preserved, since a private key is required in order to decrypt messages from the client, and a private key is required in order to re-encrypt response messages destined for the client.

Client Run Time Library

The API calls provided by the Orion client library include:
(a) Context allocation and deallocation calls: these set up a client-side context area that maintains input license parameter information provided during context allocation as well as license parameter information returned by the license server.
(b) Server license checking API calls: these include the “checkout” and “checkin” calls which result in communication with the license server with the appropriate identification and control parameters for the purpose of activation and deactivation, respectively. A “checkout” call sends the license identification and authentication information including user, product and domain identification. The license server responds with an encrypted authentication token, which is provided for a subsequent “checkin” call. In the interim, the authentication token is considered to be part of the activated state that is serialized and deserialized using “save checkout state” and “restore checkout state” described below. The authentication token encodes all necessary identification information provided in the activation request, together with client and server machine identification and system clock information as well as its assigned lease time. The authentication token is not transferable among clients or servers, and is also protected from tampering.
(c) Introspection calls for retrieving licensing attributes and information from the client-side context.
(d) “save checkout state”, “restore checkout state”, “check valid activation lease” and other API calls for managing: the serialization and encryption of the activated state to locally-generate a license key; the decryption and deserialization of the locally-generated license key to reconstruct the activated state in memory; validation of the lease start and duration attributes against the current system clock; specification and manipulation of hidden files and their content for the purpose of detecting tampering of the system clock.
   Client Protection From System Clock Tampering

Protection from tampering of the client machine's system clock is necessary even if the license is not time limited in order to support the notion of an activation lease, since the current clock is compared with the lease expiration timestamp in order to determine the lease expiry. The protection mechanism described below prevents tampering of the system clock for all scenarios including scenarios involving reformatting the client machine's disk drives and reinstalling the operating system with the system clock turned back.

There are two points in time at which system clock tampering may occur: at the time the license is activated, and subsequently at the time of an autonomous license check. The mechanisms for detecting tampering are:
(a) License Server Clock Synchronization:
   Connected-mode activation: at the time of an activation request, the client's system clock is communicated to the license server, which ensures it is within a reasonable tolerance of its system clock and also records the time difference for future calls in order to ensure the difference does not change significantly over time. If a major discrepancy in system clocks is detected, the activation request is denied.
   Disconnected-mode activation: when the license key obtained from the web self-service is decrypted and deserialized using the “restore checkout state” API call, two additional parameters are passed that control the activation and system clock checks: a “time tolerance” parameter indicating the maximum tolerated time difference between server and client clocks, and “key shelf life” parameter indicating the maximum tolerable amount of elapsed time since the key was generated. Together, the parameters serve to enforce a system clock consistency check between the license server and the client based on the checkout time and the time tolerance, and to minimize the vulnerability to future system clock changes by causing the key to perish within the allotted key shelf life.
   In either case, completion of the activation sequence causes a hidden file to be initialized with an encrypted value of the system clock at the time of activation. The location of the hidden file may optionally be controlled by the application developer, and may be varied across successive calls.
(b) Local Hidden Files:
   During steady state license checks, the hidden file is verified to exist and its contents are verified to be in a non-tampered state and having a timestamp behind the current system clock check. The system clock is also compared with a number of well-known directories' timestamps. After a successful check, the hidden file is updated with an encrypted value containing the current system clock.
      Web Browser Based Self-Service System

The self-service system consists of two web pages that are part of an Orion instance: a “get license” page and a “return license” page. These are accessed by an end user in order to complete an activation or deactivation sequence respectively when the application's activation sequence determines that network connectivity to the license server is unavailable. They may also be used by the vendor's operations personnel in order to complete an activation on behalf of such an end user when the user experiences difficulty or the license server is in fact down at the time the user attempts to perform the activation or deactivation. When the vendor ships a preconfigured hardware appliance that embeds their software in the appliance, they may also be used by the vendor's manufacturing personnel as the final step in the manufacturing assembly line if the appliance is designed to operate in isolation from a network.

A “get license” web page presents a form that asks the user for a “system fingerprint” file and, as a check against operator error, a corresponding product name. When the user submits the necessary information, the web page produces a license file that the user downloads and inputs to the waiting application activation system.

A “return license” web page presents a form that asks the user for a “return receipt” file and, as a check against operator error, a corresponding product name. When the user submits the necessary information, the web page responds with a success or failure indicator. The license is released and is reusable on another client machine only after a success indicator is returned.

License Activation and Deactivation

During license activation and deactivation, an application may interact with the Orion system in one of three modes:
(a) occasionally-connected mode: network connectivity to the license server is briefly utilized at the time of activation and deactivation, and an activation or deactivation is explicitly initiated by the user at a time that does not necessarily coincide with the normal execution of the application.
(b) connected mode: network connectivity to the license server is briefly utilized at the time of activation and deactivation; however, activation and deactivation may be implicit, and are in any case performed in the course of normal execution of the application.
(c) disconnected mode: network connectivity to the license server is never available from the application installation but is indirectly available either via a web browser connected to the license server's web self-service pages, or the vendor's support personnel who use a web browser at their premises to connect to the license server's web self-service pages. Activation and deactivation steps involve manual intervention by the user and/or vendor operations personnel to exchange system fingerprint/return receipt/license key files between the application and the browser.

In all the above scenarios, license checks by the running application are autonomous and do not require network connectivity to the license server.

License Activation and Deactivation in Occasionally-Connected Scenario

The license activation scenario in an occasionally-connected network environment, where network connectivity is utilized only at the time of activation and deactivation, is illustrated in FIG. 3.

Occasionally-Connected Mode License Activation

An “activate” operation is implemented by invoking the Orion client libraries and performing auxiliary operations to perform the following steps:
1. Introspect the machine to determine its hardware and/or operating system machine fingerprint
2. Use the Orion client library to issue a “checkout” command to the license server over the network, specifying a “checkout duration” parameter corresponding to the activation lease interval determined by the vendor to be appropriate to the application and customer context, and specifying a machine ID equal to the machine fingerprint appropriately augmented with human-readable machine name information, together with other identification and authentication parameters such as product name, user name and user password (if named user), license administration domain identifier, product license password. If the license server determines that a license is available and all authentication and system clock verification checks succeed, it returns a response that includes the actual granted activation duration, and any parameter data associated with the user that was inputted either by the administrator or as a result of a prior deactivation.
3. Initialize the activation state of the application state in persistent store, optionally initializing application state based on the user parameters returned from the above checkout command.
4. Use the Orion client library to issue a “save checkout state” command to locally generate an encrypted string representing the checkout state including the inputted machine fingerprint and granted checkout duration together with miscellaneous license policy related parameters such as overall license expiration date and balance usage quota. At the same time, the Orion client library creates and initializes a hidden file with encrypted system clock information.
5. Save the encrypted string in persistent store for future autonomous license checks.
   Occasionally-Connected Mode License Deactivation

Correspondingly, a “deactivate” operation is implemented by invoking the Orion client libraries and invoking auxiliary operations to perform the following steps:
1. Load and check the license key as described under Autonomous License Checking.
2. Obtain the application installation state information that it is desired to transfer to a new installation.
3. In cooperation with the Orion client library, perform a lightweight destructive operation that will prevent the current installation from being used while it is in a deactivated state. This includes invoking the Orion client library's API call to remove the hidden file used for system clock checks.
4. Use the Orion client library in order to connect to the license server and issue a “checkin” request, providing as parameters the application installation state information.

Deactivation may fail due to a user error if it is conducted prematurely due to the activation time being less than the “minimum activation duration” configured in the license server. If deactivation fails, the license is not available for activation on another machine.

As described above, the activation and deactivation steps themselves require network connectivity to the license server. This network connectivity requirement is eliminated when the web browser based disconnected-user self-service system, described further below, is used.

License Activation and Deactivation in Disconnected Mode

FIG. 4 illustrates the license activation and deactivation scenarios in conjunction with the web self-service pages operating in disconnected mode.

Disconnected Mode License Activation

The activation logic for operating in a disconnected environment is as follows:
1. (Application activator) Introspect the machine to determine its hardware and/or operating system machine fingerprint
2. (Application activator) Create a “system fingerprint” file as follows:
   a. Use the Orion client library to initialize a client context for the product, domain, user, password, machine fingerprint and other parameters.
   b. Use the Orion client library to create an encrypted license key from the client context using the “save checkout state” API call.
   c. Create a concatenated string consisting of the encrypted license key and parameters that would ordinarily be specified to the “checkout” command including the activation lease duration and option predicates.
   d. Encrypt the concatenated string to prevent tampering by the self-service end user, and save it in a “system fingerprint” file.
3. (Application activator) Feed back the system fingerprint file to the user, instructing the user to return with the license key, and provide the user with a form to accept the license key file.
4. (“get key” web page server-side logic, upon receiving the system fingerprint):
   a. Decrypt the system fingerprint, then issue a “restore checkout state” to locally reconstruct the client context.
   b. Use the Orion client library to issue a “checkout” against the local license server with exactly the parameters that were specified for the application activator.
   c. Use the Orion client library to issue a “save checkout state” against the checked-out state to produce an encrypted string represent the license key, and save the string in a file
   d. Feed back the URL for the license file to the user as the license key.
5. (Application activator) Use the Orion client library to validate the inputted license key as described above under Autonomous License Checking, this time in a special “activation” mode which also:
   a. ensures that the client and license server system clocks are within a specified tolerance
   b. verifies that the license has been accepted within a “shelf life” number of hours from the time it was created in disconnected mode.
   c. intializes the local hidden file instead of checking for its existence.
6. (Application activator) Save the encrypted string in persistent store for future autonomous license checks.

The above logic is equally applicable to reactivating an existing activated license, for example to renew an activation lease.

Disconnected Mode License Deactivation

Correspondingly, the deactivation logic for operating in a disconnected environment is as follows:
1. (Application deactivator) Load and check the license key as described under Autonomous License Checking.
2. (Application deactivator) Obtain the application installation state information that it is desired to transfer to a new installation.
3. (Application deactivator) In cooperation with the Orion client library, perform a lightweight destructive operation that will prevent the current installation from being used while it is in a deactivated state. This includes invoking the Orion client library's API call to remove the hidden file used for system clock checks, and deleting the license key from the local persistent store.
4. (Application deactivator) Create an encrypted, tamper-proof string from the license key and the return parameters. Save it in a “return receipt” file and prompt the user to take the return receipt to the web self-service page or otherwise send it to the vendor's operations personnel.
5. (“return key” web self-service page, upon receiving the return receipt file) Decrypt the return receipt, then use the Orion client library “restore checkout state” API call to decrypt the enclosed license key to reconstruct the checkout state, and perform a “checkin” request, supplying the transfer parameters also obtained from the return receipt. Feed back the success or failure status to the user.
   Autonomous License Checking in Occasionally-Connected and Disconnected Scenarios

In the steady state, whenever an application is run in order to use it to perform its intended function, it uses the Orion client library in conjunction with auxiliary steps in order to perform autonomous license checks either at program startup or at the time of executing a license-protected business function, without communicating with the license server, as follows:
1. Introspect the machine to determine its hardware and/or operating system machine fingerprint.
2. Load the encrypted string that was produced during activation from persistent store.
3. Use the Orion client library to issue a “restore checkout state” command that decrypts the encrypted string to reconstruct the checkout state and verify that the system clock has not been tampered with by comparing the current system clock with the timestamp saved encrypted in a hidden file whose existence and validity is first verified.
4. Use the Orion client library to validate that its lease has not expired and that its machine ID matches the recomputed machine fingerprint
   Lightweight Activation and Deactivation in Connected Mode

Orion also permits a lightweight activation model that sacrifices functionality for simplicity: both activation and deactivation are implicitly performed by the application during its normal execution instead of being explicitly initiated by the end user. In this scenario, the application logic for activation is to perform the “checkout” request for a relatively short lease duration of the order of minutes to hours, and deactivation consists of a “checkin”. In between, network connectivity to the license server is not required except when the lease is detected to be expired and a reactivation is required.

This is somewhat similar to the conventional floating license model; differences are that the user may be named where the name is a unique identifier as opposed to a dependent attribute, the activation is for a specified lease duration, and a continuous network connection to a license server is not required.

As is evident from the above, a running application does not communicate with the license server, and does not require the license server to be running in order to be reliably and securely protected from unauthorized use.

Administration System

The administration system is designed to support a delegated administration model in a hosted environment. A system administrator is associated with each license repository. For each product, a single product administrator account is associated. Administrator accounts are implemented using Orion's named-user licensing model itself: a login corresponds to an activation of a named user with an associated password for a limited duration. The named users are automatically created with default passwords at the time of creation of the license repository and the addition of a product to the repository, respectively. A system administrator has the privileges to administer the accounts for itself and all product administrators, view and purge audit trail entries, and add, update and remove product definitions with floating license keys. A product administrator can add, modify and remove domains and named users other than the administration domain and user. The vendor may choose to retain system administration privileges and delegate product administration privileges to customers if Orion is deployed at the end customer site. If Orion is deployed by a License Service Provider, on the other hand, the provider may retain system administration privileges and delegate product administrative privileges to the respective vendors.

The Orion administration system is designed for remote Internet-based administration. The user interface is implemented as a set of dynamic web pages, which are resident in the Orion instance and which interact directly with the Orion server libraries. All internal API calls that are made from the administration web pages in order to perform administration operations are qualified by the encrypted authentication token that is returned from the activation call. An appropriate administration authorization level is associated with the authentication token, and is internally verified against the administration operation being attempted. This prevents a user from successfully altering the web pages in order to bypass the administration security mechanisms and perform unauthorized operations.

### Conclusion, Ramifications, and Scope

It is apparent from the above description that an improved license management system based on persistent storage of licensing state, a stateless communication protocol and a named-user license model solves the key problems of security, scalability, availability and manageability associated with current license management systems. In one embodiment where the license management system is hosted on the Internet and utilizes the HTTP Internet protocol for communication and a relational database for managing licensing state, vendors can manage their customers' licenses worldwide and gather business intelligence on the usage of their products, while at the same time alleviating their customers of the burden of installing and administering license servers at their premises.

The scope of the invention can be extended to solve a broader range of license management problems beyond protecting conventional software, including but not limited to:
1. Document content for document processing systems that incorporate scripting languages and permit executable scripts to be a part of the document content. Examples include but are not limited to Microsoft Office spreadsheets, presentation files, email messages and word processing files. Such document content can be constrained to be viewed or manipulated according to defined licensing policies and constraints that are enforced over the Internet, for example to implement user-authenticated and time-limited and self-destructing confidential legal and medical documents.
2. Network-enabled hardware-resident firmware, for example computer boot PROMs in conjunction with flash memory.
3. Complex hardware/software systems having individually-priced hardware features and capabilities, such as semiconductor manufacturing equipment. The license enforcement possible with Orion permits the system manufacturer to streamline their production assembly line and economically produce a single type of product, whose individual features are enabled initially or after the fact of a purchase and installation at a customer site using Orion's network license activation capabilities.

Furthermore, the scope of the invention can be extended to solve a broader range of problems that extend beyond license management, including but not limited to:
1. Policy-driven authentication system: since the license management system is an effective authentication service that has licensing policy attributes, it can be used as the basis for an authentication server that supports policies such as expiration dates, roles, privileges and quotas on a per-named-user basis.
2. Policy-driven network-based real-time data acquisition and distribution system: the license management system can be used to automatically disseminate or capture categorized information over a network. For example, it can be used in the following types of applications:
   1. As a back end to Radio Frequency Identification based systems for providing pricing information based on product identifiers as well as for recording purchases, on a per-product and per-store basis, such as to support time-limited pricing and define arbitrary rules and constraints on pricing as a function of time. The license management system can in turn communicate with a back office system such as a supply chain management system for the purpose of receiving pricing rules and sending inventory data.
   2. As a usage instrumentation system, for capturing categorized usage information for analysis, for example to instrument the utilization of individual modules and features in a deployed software product.
   3. As a voting system for enforcing a single weighted vote bloc per registered user within a timeframe, for example for publicly traded companies' shareholder votes.

1. An improved and scalable network based license management system that securely controls software licenses for networked or occasionally-networked applications over any local, wide area or wireless network, that allows large numbers of licensed applications, up to several hundred thousand licensed application installations or more, to be concurrently in a license-activated state on behalf of one or a multitude of software vendors, multitudes of their customers and one or a multitude of application programs, whether executing or not, with a networked license server, whether executing or not, and capable of running on a computer with average power and constructed with components of average reliability, such as a personal computer, with no assumptions about the quality of network availability, comprising:
a. A license storage means for storing in non-volatile storage on a server machine:
i. an encrypted floating license key that encodes an overall limit on the number of licenses for a given protected program, together with additional licensing policy information such as features, expiration dates and metering limits.
ii. the current activation state and machine location on a network of each activated copy of a license protected program that is activated with said network licensing system, where an activated instance may not necessarily be executing in order to be considered to be activated, and where the activated instance enters an inactive state either upon expiration of an activation lease time limit defined at the time of activation and recorded in said current activation state, or due to an explicit deactivation operation as determined by the application's software developer, and where the definition of machine location is determined by the application's software developer and may include but is not limited to any combination of a physical machine name, unique machine identification hardware parameters, or logical names defined by a proxy application such as a terminal server or web server.
b. A license server computer software program comprising:
i. a license repository comprising said license storage stored in a persistent transactional structure such as a relational database, such that both the license data and license state data stored in said license storage survive program and machine failures without loss of structural integrity, and such that said license server is not required to be running at the same time that said applications or their proxies or agents are running in order to prevent oversubscription of licenses,
ii. a license processing module that provides means to process license activation and deactivation requests over a network, said activation and deactivation requests corresponding to requests and releases of leased units of licensing maintained in said license repository and recorded individually in said license repository, the success or failure of such license activation and deactivation requests being dependent on limits and licensing policies maintained in said license repository, and such that a leased activation is automatically and implicitly deactivated upon termination of its release without requiring a cleanup process, and such that upper and lower limits may be specified on the duration of a granted activation lease
iii. a network listener module that accepts and responds to said license activation and deactivation requests from applications seeking protection over a local or wide area network and uses said license processing module to implement the requests, said network listener module utilizing a stateless network communication protocol that requires a network connection only for the duration that said license server processes said licensing request.
c. A client license library program that provides application programming interfaces to said license enabled applications for the purposes of communicating activation and deactivation requests to said license server and for managing the local generation of encrypted license keys from the activation state for possible local storage and the reconstruction and verification of the activation state from said locally generated key, such that the locally generated key may be saved in non-volatile storage in order to enable an activated program to be in a non-executing state without losing its activation status due to said program not executing, including:
i. application programming interfaces for the purpose of activating a license based on a logical or physical machine identification information such as a machine fingerprint that uniquely identifies the requester's location, and for deactivating the license, in conjunction with said license server
ii. application programming interfaces for the purpose of introspecting the properties of an activated license including application state information maintained in said license storage by said license server, licensing policy information such as expiration timestamp, and logical client machine identification information
iii. application programming interfaces for the purpose of locally generating an encrypted license key from an activation state obtained through said activation application programming interface, and autonomously reconstructing and verifying said locally generated encrypted license key without communicating with said license server, said verification including matching machine fingerprints, validating the license is for the application, and verifying that the activation duration has not expired
iv. application programming interfaces for the purpose of validating the client machine's system clock against the system clock timestamp returned by said license server during activation.
whereby said license server and application are not required to be running or have a continuous network connection in order for license protection to be in effect,
whereby said license server can accommodate a number of concurrently-active licenses that are not limited by machine processing power or memory but only by said license repository database capacity,
whereby said license server may be hosted at the software vendor's premises on behalf of all of said software vendor's customers and accessed over the Internet, thereby alleviating said customers of the responsibility of installing and administering said license server at said customers' premises.

2. The license management system of claim 1 wherein said license repository is implemented as a relational database and license checking operations are implemented with relational calculus operators,
whereby said license repository requires no cleanup procedures for expired license activation leases,
whereby said license repository may be readily used to produce reports using the SQL relational query language and using off-the-shelf SQL-based reporting tools

3. The license management system of claim 1 that incorporates an audit trail means comprising:
a. an audit trail table in said license repository
b. an audit processing module that updates said table with details of license activation and license administration events
c. an audit reporting module that permits searches and retrievals of auditing events
whereby audits may be conducted, retrospective analysis may be performed and historical reports may be generated using reporting tools or said audit reporting module

4. The license management system of claim 1 that incorporates a host access control means comprising:
a. a host access control table in said repository, said table containing access control rules based on regular expressions for allowing or denying access to individual client machines or groups of machines
b. host access control processing logic that permits licensing requests from a client machine ID provided said machine ID matches at least one access control rule allowing access, and does not match any access control rule denying access
whereby selective access to client machines may be accomplished when said license management system is hosted and accessed over public networks such as the Internet.

5. The license management system of claim 1 incorporating a license sub-grouping means comprising:
a. a license domain entity in said license repository, where a given product license may have one or more named license administration domains, said domains having license activations assigned to them instead of to said product, and said domains being assigned individual license policies and constraints that apply to license activations assigned to it
b. said client library capable of accepting a domain name parameter to an activation request call
c. said license processing module incorporating means to associate client requests with respective said domains
whereby license activations may be grouped, each group having its individual licensing policies and constraints for a number of purposes including but not limited to assigning priorities, defining roles, and grouping license activations by customers assigned customer identifiers.

6. The license management system of claim 5 incorporating means for licensing named users, comprising:
a. a named-user qualifier for said license administration domain entity in said license repository, to distinguish named-user from anonymous-user purpose of said license administration domain entity instance, so that only instances of the associated type of license activation belong to respective said domain
b. a named-user entity in said license repository where an instance of said license administration domain entity having said named-user qualifier may have zero or more instances of said named-user entity, said named user entity being uniquely identified by a user name and having as dependent attributes at a minimum an activated status indicating whether said named user is in an activated state, a machine ID attribute indicating the identity of the client machine from which the user has been activated, a timestamp indicating when the activation occurred, and an activation lease duration numeric value indicating the activation lease duration that was granted by said license processing module, and having as a dependent attribute an optional password specifier for user authentication
c. license administration means for adding, updating and removing said named users from said license repository
d. said client library capable of accepting username and optional password parameters
e. said license processing module incorporating means for associating and authenticating user name and optional password with said named user in said repository, for updating activation state and parameters of said named user entry in said license repository, and for determining activation state of said named user entry based on current system clock
whereby user licenses can be preassigned to and associated with named users via login names, product serial numbers and similar real-world entities so users can migrate their licenses among multiple machines without being able to be activated on more than one machine at any point in time.

7. The license management system of claim 6 that incorporates means for automatically transferring application installation information when said named users migrate their licenses to new machines, comprising:
a. said named user entity in said license repository having a general purpose user parameters attribute that can accommodate reasonable-sized application state information
b. said client libraries incorporating means to receive and make available to protected application said user parameter information returned from said license server in response to said license activation request
c. said client libraries incorporating means to accept user parameter information to deactivation application programming interface call from protected application for sending to said license server as part of processing said deactivation request
d. said license processing module incorporating means to retrieve said user parameter information from said named user entry during processing of said activation request to send to client, and to save said user parameter information received from client in said named user entry during processing of said deactivation request
whereby a user may conveniently and automatically transfer application settings including but not limited to user preferences when migrating the respective license to a new machine.

8. The license management system of claim 1 wherein said license management system incorporates a weighted licensing system comprising:
a. said encrypted floating license key means that encodes a weighted user limit representing a limit on the sum of weightages of license activation requests instead of a limit on the count of license activation requests
b. said license activation request means specifying a weightage value that counts towards the weighted user limit instead of a count of 1
whereby said activations may be charged according to the underlying value of the business function, thereby permitting the vendor to sell aggregate licenses across multiple business functions of differing values

9. The license management system of claim 1 incorporating a centrally-managed license activation lease duration control means comprising:
a. minimum and maximum license activation duration specification attributes in said license repository such that minimum duration may be as low as zero and as high as infinity, and maximum duration may be as low as zero and as high as infinity
b. license processing module means incorporating license activation grant procedure that ensures granted duration is no less than said minimum license activation duration and no more than said maximum license activation duration specification attribute
whereby said license management system can be used to both limit long license activation leases and to limit the frequency with which users may migrate licenses across machines and thus limit the degree to which said user licenses can be shared among multiple individuals over time

10. The license management system of claim 1 wherein said license server may manage a multitude of said license repositories
whereby said license management system may be used by a provider of license management services on behalf of a multitude of software vendors having a multitude of customers, each having a multitude of licenses for a multitude of protected applications

11. The license management system of claim 1 incorporating means for securely managing activation and deactivation of application installations having no network connectivity to said license server, comprising:
a. A proxy licensing means that has network connectivity to said license server and acts on behalf of said disconnected application installation for the purpose of requesting and releasing license activations, comprising
i. a system fingerprint comprising an encryption of said machine fingerprint, activation lease duration and other parameters provided by said disconnected application requesting activation such that the user cannot manufacture said system fingerprint or tamper with it
ii. a user interface means for receiving said system fingerprint from said disconnected application requesting activation via detachable storage media or other means such as email
iii. a proxy activation means that decrypts said system fingerprint to obtain licensing parameters supplied by said disconnected application and performs an activation request on behalf of said disconnected application, and encrypts the resulting activation state to produce an encrypted license key for return to said disconnected application via detachable storage media or other means such as email
iv. a return receipt comprising an encryption of said encrypted license key surrendered by said disconnected application as part of its deactivation, together with any parameters said disconnected application wishes to return to license server for a subsequent activation when said activation is for a named user, such that an end user cannot manufacture or tamper with said return receipt and it can only be produced by said disconnected application itself
v. a proxy deactivation means that decrypts said return receipt to obtain said license token and deactivates the license associated with said license token if it is valid and feeds back the status to the user

12. The license management system of claim 11 wherein the proxy activation and deactivation means are implemented with web self-service pages managed by said license server and accessed over the Internet from a web browser

13. The license management system of claim 11 incorporating means for automatically utilizing an available network connection or switching to disconnected mode upon detection of network communication failure, comprising:
a. said client library incorporating means for detecting specific network communication error conditions during activation and deactivation
b. said protected application incorporating means for using said client library API calls to act on communication errors to switch to operate in disconnected mode
whereby protected application may be distributed as a single binary program for deployment in all types of networked environments and for automatic adaptation to varying conditions of network connectivity during the lifetime of its deployment

14. A network license management system that securely controls software licenses for completely disconnected, occasionally-networked or networked applications over private and public networks for the purpose of preventing spoofing of the license server and cloning of license server floating license keys by vendors' customers, comprising:
a. a license server means that accepts one or more product-specific encrypted floating license keys and manages license activation and deactivation requests over a private or public network.
b. a client library means that enables an application to issue license activation and deactivation requests to said license server for the purpose of license protection.
c. a public key cryptography based secure communication means comprising
i. public key encryption library means comprising:
1. means to enable any application to generate a public key from a secret key
2. means to enable said license management system to generate a private key from said secret key using an access-control password parameter known only to software vendor, and such that said public key and said secret key for a common secret key have substantially differing values
3. means to enable any application to encrypt a clear text string with a public key to produce a public-key-encrypted cipher text that can only be decrypted with the corresponding private key, and to decrypt a private-key-encrypted cipher text string with a public key to produce the original clear text
4. means to enable said license management system to encrypt a clear text string with a private key to produce a private-key-encrypted cipher text that can only be decrypted with the corresponding public key and to decrypt a public-key-encrypted cipher text string with a private key to produce the original clear text, using an access-control password parameter known only to software vendor
ii. encrypted floating license key generation means for allowing vendor to pre-specify a product-specific secret password that is embedded in said encrypted floating license key and from which a public key is generated and made available to vendor's development staff and from which a secret key is implicitly derived by said license server software at run time and is unavailable to vendor or vendor's customers.
iii. said client library incorporating means to accept said product public key parameter and use said encryption library to encrypt all messages to said license server with said product public key and to decrypt all messages from said license server with said product public key
iv. said license server incorporating means to obtain said product private key using said encryption library and said secret password in said floating license key, and to use said product private key to decrypt all messages from said client library with said product private key and to encrypt all messages to said client library with said product private key
whereby said messages between said client library and said license server are secure from eavesdropping and tampering,
whereby said messages between said client library and said license server are secure from substitution by a spoofed server or spoofed client,
whereby said encrypted floating license key is secure from substitution with a floating license key generated by other than the software vendor who provided said product public key to said protected application and said floating license key to said license server.

15. A network license management system that securely controls software licenses for completely disconnected and occasionally-networked applications for the purpose of preventing end users from oversubscribing time limited licenses, comprising:
a. a license server means that manages license activation and deactivation requests over a network, success of said activation and deactivation requests being contingent on client system clock being within a specified tolerance of said license server system clock
b. a client library means that enables an application to issue license activation and deactivation requests to said license server for the purpose of license protection, and transmits client system clock information to said license server
c. a client library means that enables a protected application to save said license activation state in local persistent store, with activation timestamp embedded in said saved state
d. a client library means that enables said saved license activation state to be restored in normal or activation state so that state restoration procedure during activation verifies server activation clock against client clock to be within a specified tolerance and to occur within a specified key shelf life and initializes a hidden file with the current client timestamp, and so that normal restoration procedure verifies existence of hidden file and that contents of said hidden file represent a time that is behind current system clock
whereby protected applications that use said network license server for activation are secure from system clock tampering at the time of license activation even if the client operating system installation is reinitialized
whereby said protected applications are secure from system clock tampering while running autonomously
